(19) United States
(12) Patent Application Publication
(10) Pub. No.: US 2008/0245981 A1
(43) Pub. Date: Oct. 9, 2008

(54) Apparatus and method for edge detection

(76) Inventor: Thomas K. Hebert, Groveland, MA (US)

Correspondence Address: AGFA CORPORATION;PATENT DEPARTMENT, 200 BALLARDVALE STREET, WILMINGTON, MA, 01887, US

(21) Appl. No.: 11/784,079

(22) Filed: Apr. 5, 2007

(51) Int. Cl. G01N 21/86

(52) U.S. Cl. 250/559.36

(57) ABSTRACT

An edge detection system that locates the edge of a printing plate on a platesetter includes: first scratches aligned in a first direction on a support surface; a groove machined into the support surface where the groove includes two surfaces. One surface is reflective and has second scratches aligned in a second direction perpendicular to the first direction of the first scratches. The system also includes: an edge detection light source to provide a beam for scanning along a length of the support surface on a path coincident with the groove; a sensor to sense a reflected edge detection beam from the support surface; and a controller to analyze the reflected beam, where the beam reflected from the first scratches is 90 degrees out of phase with the beam reflected from the second scratches and where the beam reflected from the first scratches is high in intensity relative to the beam reflected from the second scratches.

### BACKGROUND OF THE INVENTION

The invention is in the field of imaging systems for use in the printing industry. More particularly, the invention relates to the field of edge detection of imageable printing plates or to edge detection between any two adjacent surfaces of a printing press or a platemaker, also known as a platesetter.

In the pre-press printing industry, printing plates are manufactured on imagesetters or platesetters. The older method involves the use of film on an imagesetter whereby an image is transferred to a film which, in turn, is transferred to a printing plate. Then the printing plate is mounted onto a printing press for commercial industrial printing applications such as magazines, newspapers, books, posters, etc.

An image can also be transferred directly to a printing plate, without the use of film, on a platesetter. Platesetters can be flat-bed, external drum or internal drum machines. A flat-bed machine provides a planar surface for mounting the printing plate for imaging. In an internal drum platesetter such as the Agfa Galileo™, the printing plate is mounted onto an inside surface of a drum. In an external drum platesetter such as the Agfa Avalon™, the printing plate is mounted onto an outside surface of a drum. In all of these machines, it is necessary to scan a laser beam or beams across the printing plate when mounted on the support substrate in order to transfer an image thereto. In all of these machines it is necessary to align and position the printing plates in order to allow accurate printing thereon.

In an internal drum platesetter, the plate support substrate is the inside surface of a drum which is stationary while an imaging head emits a laser imaging beam to the printing plate. Typically the imaging head is mounted on a moveable assembly or carriage that moves linearly above a surface area of the printing plate. The laser beam is designed to reciprocate back and forth across the printing plate as the carriage and imaging head move parallel to the direction of the longitudinal axis of the drum.

In an external drum platesetter, the printing plate is mounted onto the external surface of the drum. The imaging head is mounted on a moveable carriage in the vicinity of the drum. As the drum rotates, the carriage moves along the length of the drum and an image is emitted from the laser beam onto the printing plate.

A critical step in the process of transferring an image to a printing plate mounted on a platesetter, for subsequent use on a printing press, is obtaining precise alignment between successive images and the plate. An image can be skewed or improperly positioned onto the printing plate if not precisely aligned with the outer edges of the printing plate.

Many printing presses have registration pins for installing the plate onto the press. Often the plate has a series of holes punched into it (i.e. a collinear array of holes at each end of the plate) so that the plate may be placed over the registration pins on the printing press. This is done so as to duplicate the same precise alignment of the plate onto the printing press as when the plate was exposed to the image on the platesetter. When holes are punched into the plate, precise alignment between the holes and the outer edges of the plate is also required.

An alternate method of installing and aligning (known as registering) plates onto printing equipment, such as platesetters and printing presses, is to simply place an outer edge of a plate up against a registration pin. The outer edges of the plate are then determined by various known methods and the image area is defined with respect to the outer edges of the plate. Alignment errors are directly proportional to the accuracy in determining the edges of the plates.

Various methods have been employed to detect an edge of a printing plate. These methods include mechanical switches, optics, and electrical sensing techniques coupled with software. Each technique has its own advantages and disadvantages. For example, mechanical switches cannot detect the edge of a plate with the same resolution that is used to create the image. Further, mechanical edge detection techniques can sometimes damage the plate.

Light reflection techniques for edge detection rely on measuring and monitoring the difference in contrast between different surfaces, i.e. determining the difference in reflected light from different adjacent surfaces. However, attempting to rely on differences in projected focal area between surfaces to reflect different amounts of light can be difficult. Consider that the amount of light reflected from a surface will vary depending on the size of the light spot (focal area) of the surface. A large spot, with lower light density, reflects less light toward a remote point, than does a small spot with higher light density. A thin plate mounted on a support surface produces a very small difference in focal area (spot size) when the spot is on the plate verses when the spot is incident to the support surface. Consequently the difference in reflected light is very small and difficult to detect.

If one can provide large differences in the amount of reflected light between any two surfaces, then the need for complex signal analysis is lessened. Thus if the reflectivity between two adjacent surfaces is sufficiently different, then a large difference in the amount of light reflected from each surface will result even if the two surfaces are co-planar. An example is a piece of white paper next to a piece of black paper. The white paper reflects a large amount of light, whereas the black paper reflects little light, but absorbs a large amount of light. Hence, detecting the reflected light when traversing from the white to the black paper will provide a clear boundary point of the edge.

U.S. Pat. No. 7,057,196 issued on Jun. 6, 2006 to Fischer et al. discloses an external drum platesetter with a printing plate mounted on the external surface of the drum. An edge of the printing plate is secured onto the drum by a clamping strip. An exposure head is moved axially along the drum and focuses one or more laser beams onto the drum surface, where the laser beam sweeps over the drum surface in the form of narrow helices. In order to determine a side edge of the printing plate mounted on the drum, an optical fiber is provided and inserted into a suitable groove in the surface of the drum and extending in an axial direction. Fitted at one end of the optical fiber is a photodetector that receives light propagated in the longitudinal direction of the optical fiber. Using an illumination device that includes a laser diode and focusing optics, light is radiated into the optical fiber with the drum at a standstill, while the illumination device is moved axially along the drum in the y direction. The illumination device is fitted to the exposure head and is moved in the axial direction together with the latter. The light radiated into the optical fiber propagates in the longitudinal direction of the optical fiber and is received by the photodetector. As soon as the illumination device crosses the left-hand side edge of the printing plate during its movement in the y direction, the light radiated is covered by the printing plate, and the electrical signal output by the photodetector is attenuated highly. By counting the cycles of the feed drive, the y position at which the signal change occurs can be determined. The Fischer patent is limited by the need for an implanted optical fiber into the surface of the drum.

U.S. Pat. No. 6,915,743 issued Jul. 12, 2005 to Blohdorn et al. discloses a system and method that detects the edge of a printing plate by a sensing device. A sensing finger is pivoted into a groove in the surface of the external drum and a signal is generated by a sensor when the sensing finger touches the edge of the recording material, e.g. a printing plate. This system relies on both mechanical and electrical components. Malfunction of the mechanical sensing finger could potentially damage the edge of a printing plate.

U.S. Pat. No. 6,815,702 issued on Nov. 9, 2004 to Kiermeier et al. discloses a method and apparatus for detecting an edge of an imageable media mounted on an external drum of a platesetter for imaging printing plates. The Kiermeier apparatus includes: a moveable assembly or carriage having a light source and a light sensor responsive to light from the light source; a groove formed into an outside surface of the external drum, where the groove has an anti-reflective layer disposed on a surface of the groove.

The Kiermeier anti-reflective layer may include, but is not limited to, black velvet, black paint, black oxide coating, black cloth/plush material, black polymer or any other material that absorbs all, or essentially all of the light from the ‘light source’ that is incident upon the anti-reflective layer. Alternatively, the anti-reflective layer may be any material having a color whose peak absorbance wavelength is matched to the wavelength of the light source so that essentially all of the light from the source is absorbed. The addition of the anti-reflective layer to the groove creates a difference in the reflected light between the printing plate and the drum surface, in turn increasing the signal-to-noise ratio so that accurate detection of the edge of the printing plate can be obtained.

The carriage is moved parallel to the longitudinal axis of the drum so that light from the light source is applied along a path of the groove on the drum, the light being generally normal to the surface of the groove. The absence of reflected light from the anti-reflective layer of the groove is received by a light sensor as a first signal level by the light sensor. When the light passes over a printing plate (having no anti-reflective layer) mounted on the drum, then a considerable amount of light is reflected and received by the sensor as a second signal level by the light sensor. Thus by monitoring the reflected light, a signal processor can determine the edge of the printing plate when a difference between the first and second signal levels exceeds a predetermined value.

However, certain drawbacks pertain to the Kiermeier device. For example, an anti-reflective layer such as black velvet tends to burn or otherwise become loose or damaged due to constant exposure to radiation. The same applies to any coating which can be burned or rendered less useful by continuous exposure to light. Hence these coatings and layers require maintenance and replacement from time to time.

### SUMMARY OF THE INVENTION

It is an object of the invention herein to provide an improved method and system for accurately detecting an edge of an imageable printing plate mounted on a substrate or support surface with minimal need for maintenance or repair.

### BRIEF DESCRIPTION OF THE DRAWINGS

The aforementioned aspects and other features of the invention are described in detail in conjunction with the accompanying drawings, not drawn to scale, in which the same reference numerals are used throughout for denoting corresponding elements.

FIG. 1 is a schematical side view of a preferred embodiment of an edge detection system in accordance with the principles of the invention;

FIG. 2 is a prior art diagrammatic view of light as reflected from a drum surface of a platesetter, machine ground in a direction D;

FIG. 3 is a diagrammatic view of light reflected from a groove in a drum surface of a platesetter, machine ground in a direction E, in accordance with the principles of the invention;

FIG. 3A is a prior art diagrammatic view of light reflected from a printing plate;

FIG. 4 is a side perspective view of an external drum for imaging machined in accordance with the principles of the invention;

FIG. 5 is a top perspective view of an external drum for imaging with a printing plate mounted thereon in accordance with the principles of the invention;

FIG. 6 is a partial cutout view of edge detection of a notch on a printing plate in accordance with the principles of the invention; and

FIG. 7 is a graph of reflected light intensity versus location of the reflected light beam from a printing plate mounted on a drum.

### DETAILED DESCRIPTION OF THE PREFERRED EMBODIMENTS

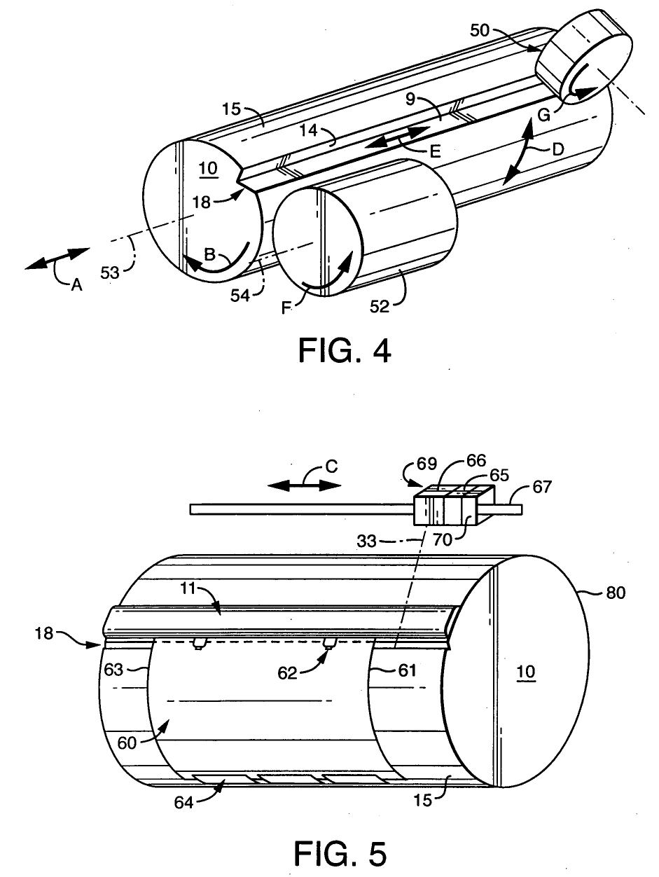

A typical method of manufacturing a drum for an external drum platesetter is to machine the drum to a desired diameter, then grind the external drum surface to the final requirements. The process of grinding involves rotating the drum against a rotating grind wheel as the latter is moved axially along the drum surface. For example, a grinding wheel 52 can be used to rotate in a direction F about its axis 54 to grind the drum 10 rotated in a direction B as illustrated in FIG. 4. Due to the rotational grinding, the result is a finished external drum surface with micro scratches oriented in the radial direction D of the grind. When light is incident on this drum surface 15, diffraction occurs as if by illumination through a slit. The result is a reflected pattern perpendicular to the scratches. The scratches are drum-wise radial in the direction D as shown, and so produce an axial spot orientation as shown in FIG. 2. The further from radially normal, the less radiation there is to collect. Regardless of the reflectivity of the drum surface, there is little radial scatter.

Optical systems like to “look” off axis to prevent radiation reflection into the system. This works as a result of twice the incident angle, or the reflected angle created. Light reflected at an angle greater than the exit aperture of the system will be omitted. But, a system that both emits and detects radiation wants to omit and collect reflection, if at different times. A somewhat circular beam will reflect an elliptical off axis (not normal) spot from a plane surface. And the major axis of that ellipse will be in the plane of the included angle. A plane surface of curvature results in a similarly oriented, similarly elliptical spot.

The optical system of the preferred embodiment (see FIG. 5) of the current invention for an external drum platesetting system includes a writing beam (not shown) emitted from a writing beam source 65 for transferring an image to a printing plate 60 mounted on an external surface 15 of a drum 10, and an auto-focus beam 33 emitted from an auto-focus beam source 66 for focusing the system. The auto-focus beam detects surface variation ahead of the writing beam to correct the focus position of the writing beam. Both the writing beam source 65 and the auto-focus beam source 66 are included in the optical head 69 or carriage which is mounted onto a carriage beam 67 that extends the length of the drum 10. During imaging the optical head 69 moves in a linear direction C while the plate and drum are rotating so that the writing beam can transfer an image onto the printing plate.

Prior to imaging, it is desirable to utilize the auto-focus beam 33 to detect edges of the surfaces to which the writing beam will engage to provide proper image placement on the printing plate 60. Specifically, we wish to establish the locations of the edges 61 and 63 of the printing plate 60. One way to accomplish this is by measuring and comparing the contrast ratios of the surfaces being scanned. That is, an edge can be detected by monitoring and measuring the difference in reflected energy of adjacent surfaces which have different reflective characteristics. In this case we wish to detect the exact location of the border between the drum surface 15 and groove 18, with the printing plate 60 mounted on the drum surface.

When a drum surface 15 is manufactured, a first grind wheel 52 grinds the drum surface in a first direction D which is circumferential to the drum, yielding first scratches aligned in the first direction D (see FIG. 4). In order to make the apparatus of the current invention, a second grind wheel 50 turns in the direction G to grind a groove 18 into the drum surface in a second direction E perpendicular to the first direction D. The groove 19 ends up with second scratches aligned in the second direction E where the direction of the second scratches is essentially perpendicular to the direction of the first scratches aligned in the direction D.

If a light such as a laser beam is emitted to a drum surface having the first scratches as defined above, the scattered light reflected from that surface will be optically π/2 radians or ninety degrees out of phase with the light reflected from the surface having the second scratches. In other words a light energy measurement of a laser beam reflected from the drum surface with first scratches will be lower whereas the light energy measurement of the laser beam reflected from the drum surface with second scratches will be higher from the perspective of an off-axis collector/detector.

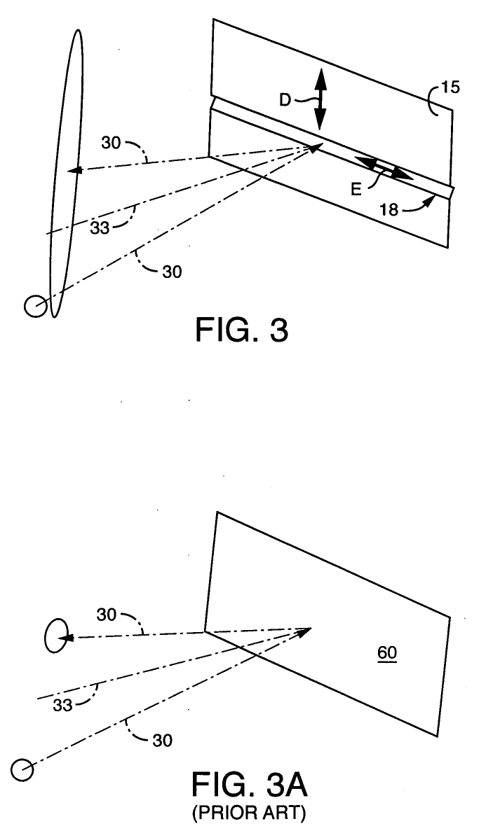

FIGS. 2, 3 and 3A illustrate differences in the reflected light characteristics based on the different reflective surfaces. In FIG. 2, a laser beam 33 is emitted to a drum surface 15. The reflected beams 30 exhibit a relatively low intensity. Significant diffraction occurs due to the first scratches on the drum surface 15. In FIG. 3, the laser beam 33 is emitted to a surface 9 of a groove 18. The reflected beams 30 exhibit a relatively high intensity with respect to the reflected beams 30 from the drum surface 15 shown in FIG. 2. Again, significant diffraction occurs this time due to the second scratches on the groove surface 9. Furthermore, note that the reflected beams of FIGS. 2 and 3 are optically π/2 radians or ninety degrees out of phase with one another. FIG. 3A depicts the laser beam 33 emitted to the printing plate 60. Since the printing plate does not contain scratches such as on the drum 15 or groove surface 9, very little of the reflected light is diffracted. The reflected beams 30 again exhibit a relatively low intensity (when compared to the reflected beams from the groove surface 9), as with the reflected beams 30 from the drum surface 15. Hence, a measurement of the reflected beams 30 from the drum surface 15, the groove surface 9, or the printing plate 60 will show clear distinctions in intensity and phase as discussed above.

In this preferred embodiment, a groove 18 is machined into the surface 15 of the drum 10. The groove 18 includes 2 surfaces 9 and 14 whereby, with respect to the surface of the cylindrical drum, surface 9 is more nearly glancing or tangent, and surface 14 is nearly normal. In other words, (1) the angle θ is a small acute angle defined between the surface 9 and the tangent of the circumference of the drum 10, and (2) the surface 14 is essentially perpendicular to the tangent of the circumference of the drum. In alternate embodiments, (1) the groove 18 could be machined to have more than 2 surfaces 9 and 14, (2) the angle θ could be other than a small acute angle, and (3) groove surface 14 could be other than essentially normal to the tangent of the circumference of the drum.

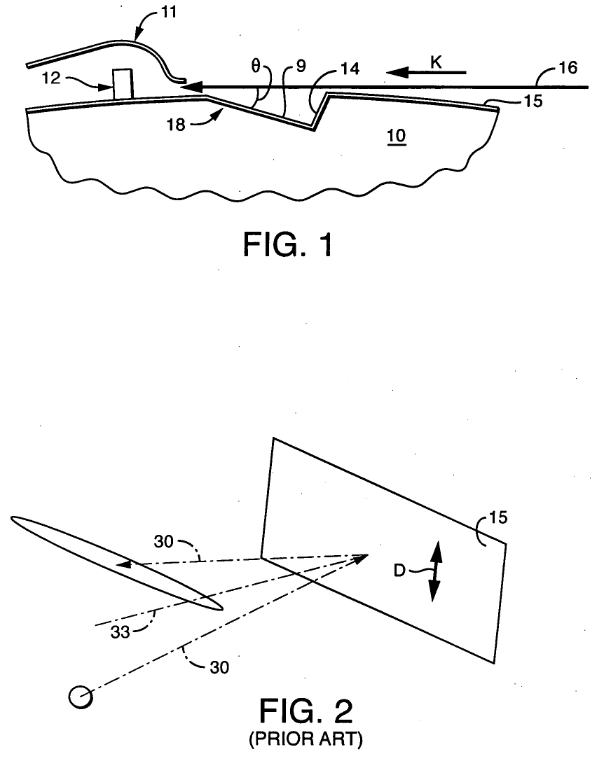

At least one surface 9 has been ground with the second grinding wheel 50 to yield second micro scratches thereon. The second scratches could alternately be burnished directly onto the drum surface 15 without the use of a groove 18. However, second scratches that are located directly on the drum surface 15 are susceptible to being tainted, damaged or compromised, for instance by printing plates that slide across the drum surface 15 during mounting and which over time can alter the composition and reflective effect of the overall surface and the defractive quality of the second scratches. Further by using a 2 surface groove as shown, plate loading will not be encumbered or caught, by a vertical surface since a printing plate 16 is loaded as shown in FIG. 1 to smoothly slide into the clamp 11. By applying the second scratches into the groove 18 which is slightly below the drum surface 15, printing plates (which are planar and typically are composed of materials such as aluminum so as to be quite stiff) being loaded onto the drum in the direction K will never come into direct contact with the surface 9 or the second scratches. Rather, the leading edge 19 of the plate 60 is slid over the nearly tangential surface then under, and secured by, the leading edge clamp 11. For this reason, the positioning and order of the two surfaces is critical when detecting close to the clamp.

Edge detection is accomplished by first mounting the printing plate 60 onto the drum surface 15 and securing the plate with the leading edge clamp 11. In this preferred embodiment, the auto-focus beam is used for edge detection as well as for auto-focusing. Another independent laser or light beam could be allocated for edge detection if desired.

The optical head which includes the auto-focus beam source 66 or other suitable emitter is positioned above the groove 18, and is moved in a linear direction C along the support beam 67 while the auto-focus beam 33 is emitted along a linear path coincident with the groove 18. The beam 33 is reflected from the surface 9 of the groove 18 and the reflected light is sensed by a photo detector or light sensor 70 which is located on the carriage 69 as the beam 33 traverses from one end of the drum to the other.

The intensity of the reflected auto-focus beam 33 is sensed and measured as the beam 33 traverses along the groove 18 for the length of the drum. For example, FIG. 7 represents a graph of intensity signals of reflected light from the beam 33 sensed by the sensor 70 as the edge detection starts along the groove 18 at a position M corresponding to a start point such as the end 80 of the drum 10. The carriage 69 is moved in the direction C away from the end 80 until a point N on the graph is reached corresponding to the position of the plate edge 61. The intensity of the reflected beam is substantially decreased as light is reflected from the printing plate 60. As the carriage 69 continues to move in the direction C, eventually the edge 63 of the plate 60 is encountered by the beam 33, corresponding to the point P on the graph of FIG. 7. Point P on the graph represents the plate edge 63 when the beam 33 transitions from the plate surface to the groove 18.

The location vs. intensity chart of FIG. 7 can also be analyzed in view of the phase of the beam 33 as it traverses along a path coincident with the groove 18. As illustrated in FIGS. 2, 3 and 7 the beam 33 when reflected from the groove 18 between points M and N corresponding to the groove 18 is 90 degrees or π/2 radians out of phase with the beam 33 when reflected between the points N and P corresponding to the printing plate 60.

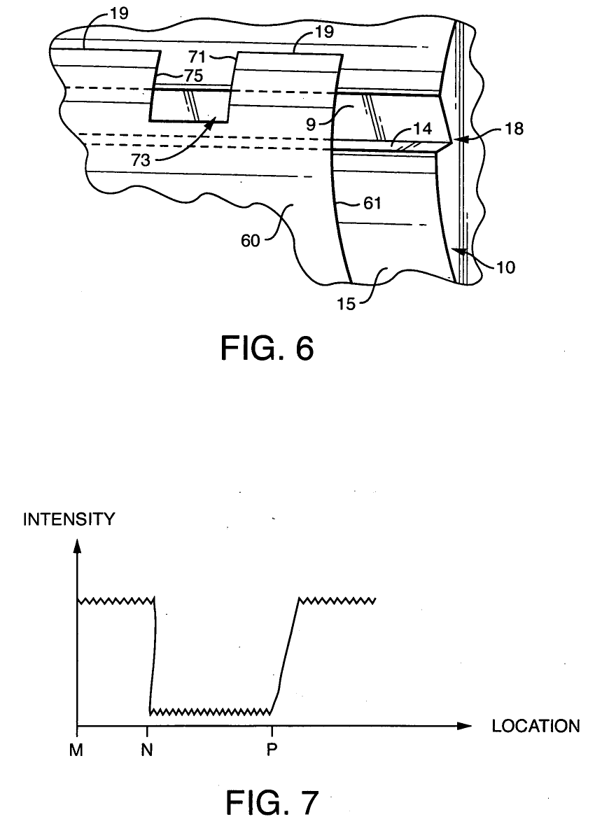

FIG. 6 illustrates an application of the inventive edge detection system and method whereby a printing plate 60 includes a notch 73. As the auto-focus beam 33 is moved along the surface 9 of the groove 18, it will encounter and detect the edge 61 of the printing plate and the edges 71 and 75 of the notch 73 in the same manner as described above.

While this invention has been particularly shown and described with reference to selected examples or embodiments, the principles of the inventive system and method are applicable for detecting an edge between any two adjacent surfaces as defined in the claims. For instance, the support for the printing plate could be the external surface of a drum for an external drum platesetter, an internal surface of a drum for an internal drum platesetter, or a planar support for a flatbed platesetter.

1. An edge detection system for use with a platesetter for imaging a printing plate, the platesetter comprising a support surface and a system for transferring an imaging laser beam from an imaging source to the printing plate to expose an image on the printing plate, the edge detection system comprising:
first scratches aligned in a first direction on the support surface;
a groove machined into the support surface, said groove comprising two surfaces, one said surface being reflective and having second scratches aligned in a second direction perpendicular to the first direction of the first scratches;
an edge detection light source to provide an edge detection beam for scanning along a length of the support surface on a path coincident with the groove;
a sensor to sense a reflected edge detection beam from the support surface; and
a controller to analyze the reflected beam, wherein the beam reflected from the first scratches is 90 degrees out of phase with the beam reflected from the second scratches and wherein the beam reflected from the first scratches is high in intensity relative to the beam reflected from the second scratches.

2. An edge detection system for use with an imaging system comprising a drum having first scratches aligned in a first direction due to grinding of the drum during manufacture, a printing plate mounted on an external surface of the drum and held in place by a clamping system, an imaging laser light source mounted on a moveable carriage to provide scanning of laser light to expose an image on the printing plate, the edge detection system comprising:
a two-surface groove machined into the external surface of the drum along a length of the drum and parallel to the center axis of the drum, said groove comprising two surfaces, a near-normal surface being substantially normal to a tangent of a cylindrical surface of the drum, and a near-glancing surface forming an acute angle with the tangent of the cylindrical surface of the drum, said near-glancing surface being a reflective surface having second scratches ground in a second direction;
an edge detection laser light source mounted on the carriage to provide an edge detection beam for scanning along the length of the drum coincident with the reflective near-glancing surface of the groove;
a sensor mounted on the carriage to sense a reflected edge detection beam; and
a controller to analyze the reflected beam, wherein the beam reflected from the first scratches is 90 degrees out of phase with the beam reflected from the second scratches and wherein the beam reflected from the first scratches is high in intensity relative to the beam reflected from the second scratches.

3. An edge detection method for use with a platesetter for imaging a printing plate, the platesetter comprising a support surface with a groove machined therein and a printing plate mounted thereon, the edge detection method comprising the steps of:
emitting an edge detection beam along a path coincident with the groove on the support surface;
detecting a reflected edge detection beam having a first intensity and a first phase due to reflection from first scratches on the support surface aligned in a first direction;
detecting a reflected edge detection beam having a second intensity and a second phase due to reflection from second scratches on a surface of the groove aligned in a second direction substantially perpendicular to the first direction of the first scratches; and
analyzing the reflected beam to determine a location of an edge of the printing plate wherein the beam reflected from the first scratches is 90 degrees out of phase with the beam reflected from the second scratches and wherein the beam reflected from the first scratches is high in intensity relative to the beam reflected from the second scratches.
